(19) United States
(12) Patent Application Publication
(10) Pub. No.: US 2013/0011492 A1
(43) Pub. Date: Jan. 10, 2013

(54) ELECTROCHEMICAL DEPOSITION OF NOBLE METAL AND CHITOSAN COATING

(75) Inventors: Gary HALADA, Baiting Hollow, NY (US); Michael A. CUIFFO, Nesconset, NY (US); Prashant JHA, Palatine, IL (US)

(73) Assignee: The Research Foundation of State University of New York, Albany, NY (US)

(21) Appl. No.: 13/594,288

(22) Filed: Aug. 24, 2012

Related U.S. Application Data
(63) Continuation-in-part of application No. PCT/US2011/026075, filed on Feb. 24, 2011.
(60) Provisional application No. 61/596,954, filed on Feb. 9, 2012.
(60) Provisional application No. 61/692,513, filed on Aug. 23, 2012.

(51) Int. Cl. C25D 15/00; A01P 1/00; C25D 5/00; A01N 59/16

(52) U.S. Cl. 424/618; 205/109; 205/320

(57) ABSTRACT

A method of electrochemical deposition includes submerging a stainless steel surface of an object in a chitosan solution and applying a first electric potential between the submerged stainless steel surface and the chitosan solution for a predetermined time to form a chitosan surface coating. After rinsing and dehydrating, the chitosan coated surface is submerged in a solution having a predetermined concentration of a noble metal nitrate and a second electric potential is applied between the chitosan coated surface and the solution of the noble metal nitrate to deposit noble metal particles on the chitosan surface coating.

### PRIORITY

This application is a Continuation in Part of International Application No. PCT/US2011/026075, with an international filing date of Feb. 24, 2011, and claims priority to U.S. Provisional Applications No. 61/596,954 and 61/692,513, filed with the U.S. Patent and Trademark Office on Feb. 9, 2012 and Aug. 23, 2012, respectively, the contents of each of which are incorporated herein by reference.

### BACKGROUND OF THE INVENTION

1. Field of the Invention

The present invention relates generally to a method of aqueous electrochemical deposition to coat a metallic surface with chitosan and metal nanoparticles.

2. Background of the Related Art

Metal nanoparticles act as catalysts in a variety of chemical processing methods, including conversion of organic compounds for use in energy generation such as polymer membranes for hydrogen fuel cells, chemical synthesis such as carbon-carbon bond formation, and oxidation reactions. Fabrication of catalytic metal nanoparticles including Silver (Ag), Gold (Au), Platinum (Pt) and Palladium (Pd) typically involves a three stage process that requires a metal salt in solution; a shaping or encapsulation agent, which is usually an organic molecule such as chitosan; and a strong reducing agent to reduce metal ions for the formation of nanoparticles. For example, Huang, et al., Colloids and Surfaces B: Biointerfaces, 39 (2004), pages 31-37, discloses metal-chitosan nanocomposites through reduction of Ag, Au, Pt and Pd salts in the presence of chitosan through exposure to sodium borohydride, as a rapid process. However, the third stage of the fabrication is highly reactive and can create an environmental or health hazard.

Chitosan is a linear polysaccharide of 2-amino-2-deoxy-D-glucopyranose obtained by deacetylation of chitin from crustaceans, mollusks, insects or fungi. Chitosan is the second most abundant natural biopolymer and there are broad ranges of applications for Chitosan.

Chitosan, as well as chitosan loaded with an antibiotic such as gentamicin, are biocompatible and have been applied to stainless steel bone screws to inhibit bacteria growth. Additionally, a chitosan film including titanium substrates is used in dental implants. However, the chitosan-titanium film requires silane coupling agents to create a bond between the chitosan and the titanium. This requires a complex process involving several chemical treatments, including curing at elevated temperatures, reaction with a cyano-oxysilane coupling agent and overnight exposure to a glutaraldehyde cross-linking agent. While biomedical and pharmaceutical applications have been exploited for some time, potential uses of chitosan-based biomaterials in industry, such as chitosan loaded with gentamicin or titanium, are hindered by questions of stability, variability in properties, and production considerations.

Surfaces for flexible electronics, sensor surfaces and device development require polymeric materials having high levels of elasticity, toughness and environmental durability. In particular, durability and mechanical toughness, as well as adhesion to metal substrates, are challenges to applications that utilize chitosan.

Conventional processes generally require use of ionic solvents for chitosan deposition on metal substrates. Such processes and agents are undesirable and are often environmentally unsafe. An example of an environmentally unsafe method is provided by Huang et al., Colloids and Surfaces A: Physicochem. Eng. Aspects 226 (2003), pages 77-86, which describes techniques for incorporation of Au nanoparticles in a chitosan matrix. Huang requires pre-forming of the Au particles and stabilizing using citrate in a strong acidic solution prior to incorporation in chitosan, and also requires use of glutaraldehyde as a cross-linking agent. Huang et al., Journal of Colloid and Interface Science 282, (2005), pages 26-31, describes a process, which requires use of sodium borohydride, which is a hazardous reducing agent, as does Adlim et al., Journal of Molecular Catalysis A: Chemical 212 (2004), pages 141-149, in regards to obtaining Pt and Pd chitosan nanoparticles. Further, Huang et al., Carbohydrate Research, 339 (2004), pages 2627-2631, describes a method for synthesizing Au and Ag nanoparticles, but requires elevated temperatures reaching 70° C. during the process. Raveendran et al., Journal of the American Chemical Society 125 (2003), pages 13940-13941, attempts to provide an environmentally benign, i.e. “green”, synthesis of Ag nanoparticles, but also requires elevated temperatures.

Accordingly, there is a need for an environmentally benign process for aqueous deposition of chitosan composite coatings via an electrophoretic process, which requires fewer harsh reducing agents and hazardous solvents, and occurs near ambient temperatures.

### SUMMARY OF THE INVENTION

The disclosed method overcomes the above shortcomings by providing methods of electrochemical deposition.

A method of sequential deposition is provided that includes submerging a stainless steel surface of an object in a chitosan solution and applying a first electric potential between the submerged stainless steel surface and the chitosan solution for a predetermined time to form a chitosan coating on the surface. The chitosan coated surface is rinsed and dehydrated. The method includes submerging the chitosan coated surface in an aqueous solution having a predetermined concentration of a noble metal nitrate and applying a second electric potential between the chitosan coated surface and the solution of the noble metal nitrate to deposit noble metal particles on the chitosan coated surface.

According to an embodiment of the present invention, a method for electrochemical deposition is provided to simultaneously form a coating on a stainless steel surface. The method includes submerging the stainless steel surface in an acidic chitosan solution with a predetermined concentration of a cationic noble metal and applying an electric potential between the submerged stainless steel surface and the acidic chitosan solution for a predetermined time to form a matrix of the cationic noble metal and nitro-chitosan on the submerged stainless steel surface. The method includes forming a functionally graded layer on the stainless steel surface including a semi-crystalline matrix of the cationic noble metal and chitosan.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 illustrates electrochemical deposition on a surface in accordance with an embodiment of the present invention;

FIG. 2 illustrates a Scanning Electron Microscope (SEM) image showing cross-sectional distribution of silver (Ag) nanoparticles within a chitosan coating deposited onto a stainless steel substrate according to the present invention;

FIG. 3 is an SEM surface image of Ag nanoparticles formed near a chitosan surface layer deposited on stainless steel according to the present invention;

FIG. 4 illustrates a chitosan-based coating formed on stainless steel according to the present invention;

FIG. 5 is an X-ray Absorption Near Edge Spectroscopy (XANES) data chart of X-ray absorption energy versus intensity of an Ag foil standard and of Ag nanoparticles formed in chitosan on stainless steel according to the present invention;

FIG. 6 shows Synchrotron Fourier Transform InfraRed (FTIR) spectra of a chitosan-Ag nanoparticle coating obtained according to the present invention and of a pure chitosan coating;

FIG. 7 provides comparative graphs of synchrotron Extended X-ray Absorption Fine Structure (EXAFS) spectroscopy of an Ag nanoparticle containing chitosan coating according to the present invention to an Ag foil standard;

FIG. 8 illustrates an assessment of bonding strength of chitosan electrochemically deposited on stainless steel according to the present invention;

FIG. 9 is a flowchart summarizing a method for simultaneous electrochemically-induced deposition according to the present invention; and

FIG. 10 is a flowchart summarizing a method for sequential electrochemically-induced deposition according to the present invention.

### DETAILED DESCRIPTION OF EMBODIMENTS OF THE PRESENT INVENTION

A description of detailed construction of certain embodiments is provided to assist in a comprehensive understanding of these embodiments of the invention. Those of ordinary skill in the art will recognize that various changes and modifications of the embodiments described herein can be made without departing from the scope and spirit of the invention. Descriptions of well-known functions and constructions are omitted for clarity and conciseness.

In accordance with an embodiment of the present invention, a rapid technique is provided for utilizing room temperature aqueous solutions for electrochemical deposition of a chitosan/noble metal coating. Electrochemical deposition allows for use of a reduced number of metal ions in the design and development of composites, with the entire process performed in an environmentally friendly manner. An electrochemical method and an antimicrobial coating for polysaccharide attachment and film growth are provided herein via electron transfer to generate the polysaccharide layer on a passivated stainless steel surface, similar to formation of biofilms by bacteria during biofouling. See, U.S. Pat. No. 7,381,715 to Sabesan for background regarding a chitosan-metal complex, the contents of which are incorporated herein by reference.

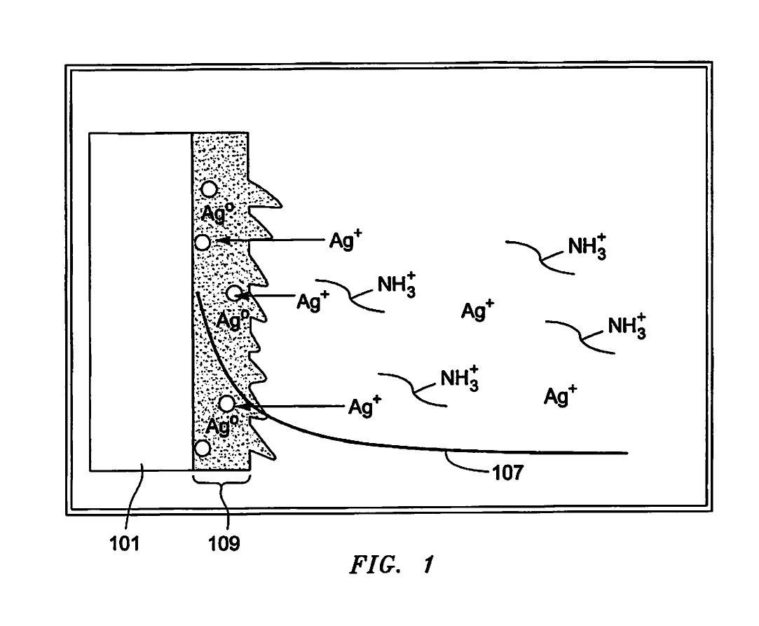

FIG. 1 illustrates coatings deposited utilizing the room-temperature solution via electrostatic attraction. In FIG. 1, chitosan is electrophoretically deposited on stainless steel, primarily by applying a voltage to generate an elevated pH, preferably greater than 6.3, adjacent to a surface of cathode 101, as well as by electrostatic attraction of cationic chitosan from the solution to surface 101.

As shown in FIG. 1, localized, near-surface changes in pH are created by polarization of surface 101, i.e., a stainless steel substrate. A strong surface adhesion occurs due to association of chitosan functional groups with chromate and other oxyanions in a functionally graded passive layer 109 adjacent to surface 101, with deposition performed under normal atmospheric conditions. A chitosan film develops on the stainless steel substrate, with a pH gradient 107 elevating to above 6.3 as distance to the stainless steel substrate decreases.

Applied voltage provides a rapid, simple way to form metallic nanoparticle structures in chitosan. Metallic nanoparticle spatial distribution in the chitosan coating, i.e. a matrix of chitosan film formed on the surface of the electrode, is controlled through a processing methodology, which allows for patterned deposition. Patterned deposition is obtained by application of pulsed voltage, thereby creating a layered structure.

FIG. 2 is an SEM image of a two micron cross section area showing a coating obtained by the method of the present invention on an ion beam-machined sample. Varied control of processing parameters, including pulsing of deposition potential, produces the layered structures containing silver (Ag) nanoparticles that are shown in FIG. 2, with depositions of a first layer 202 on surface 101 and a second layer 204 on the first layer 202. In accordance with an embodiment of the invention, an electric potential is applied between surface 101 and an acidic chitosan solution for a predetermined time, as described below, to form the first layer 202 including a matrix of the cationic noble metal and nitro-chitosan thereon, with the nitro-chitosan providing improved adherence of the first layer 202 to the surface 101. The second layer 204 includes a semi-crystalline matrix of the cationic noble metal and chitosan forms over the first layer 202.

A passive film on stainless steel includes an inner layer of kinetic metal oxide barriers and oxyhydroxides, and an outer layer enriched in oxyanions. Since polysaccharides, including chitosan, are known to bind to chromate and other oxyanions in solution, an initial chitosan layer is created through electrostatic interaction with a cathodically charged stainless steel surface. In accordance with an embodiment of the invention, a type 304 stainless steel is utilized, the composition of which is known in the art. After creating the Ag-chitosan matrix, a phenomenon of heightened adherence, which includes an improved mechanical strength, is observed based on inclusion of the nitro-chitosan in the first layer 202, potentially further improved due to association of Chromium (Cr) (VI) with amine groups. This phenomenon contributes to initial film formation and enhances mechanical properties, including adhesion.

An electrochemical deposition method is used to deposit a chitosan/noble metal nanoparticle coating on a stainless steel surface. In accordance with an embodiment of the invention, type 300 series stainless steel provides a preferred reactive surface for deposition due to a passive layer that allows strong film adhesion. Deposition on type 304 stainless steel (18% Cr, 8% Nickel (Ni), bal. Iron (Fe)) at a cathodic potential is rapid, with a thick layer of approximately 2-10 microns developing within three seconds to five minutes.

Cathodic polarization of a stainless steel surface in a mildly acidic chitosan solution results in formation of an adherent and functionally graded process. Cationic chitosan is attracted to the cathodically-polarized surface where an initial, strongly bound layer is formed through complexation between amine (NH₂) groups and chromate oxyanions in an outermost layer of the passive film. Through a deprotonation mechanism, chitosan is deposited from solution due to the pH gradient near the stainless steel electrode surface. Trapped hydroxyl radicals generated by the cathodic process oxidize C—OH and amine groups to form carbonate-like and nitrate-like functionalities.

After the cathode is removed from the solution, Ultra-Violet (UV) light exposure may be applied to dry the coating and further enhance the reactivity of hydroxyl radicals with chitosan, resulting in additional nitro groups. The dried coating develops with additional beneficial mechanical and adhesive properties, and enhances crystallinity by multiple forms within a functionally-graded structure. Introduction of a dilute noble metal ion to the solution, such as from dissolution of an Ag salt, facilitates growth and retention of stable metal nanoparticles for biomedical, catalysis, sensor and other applications such as water filtration and nuclear test containment is possible. The method of the present invention provides a durable coating with an improved mechanical durability for interfacing with other materials. For example, a deposited Ag nanoparticle/chitosan composite provides an anti-biofouling coating.

FTIR and Raman spectroscopy were used to provide chemical analysis of functionalized polysaccharide nanostructured materials and coatings. The Raman spectra from the electrochemically deposited coatings indicate a higher intensity in the primary amine bands, and occasionally in the phenolic region, as compared to stock powder. X-ray Photoelectron Spectroscopy (XPS) was utilized as a surface sensitive technique to analyze C, N and O speciation and chemical environment to a depth of approximately 10 nm, to confirm surface chemistry.

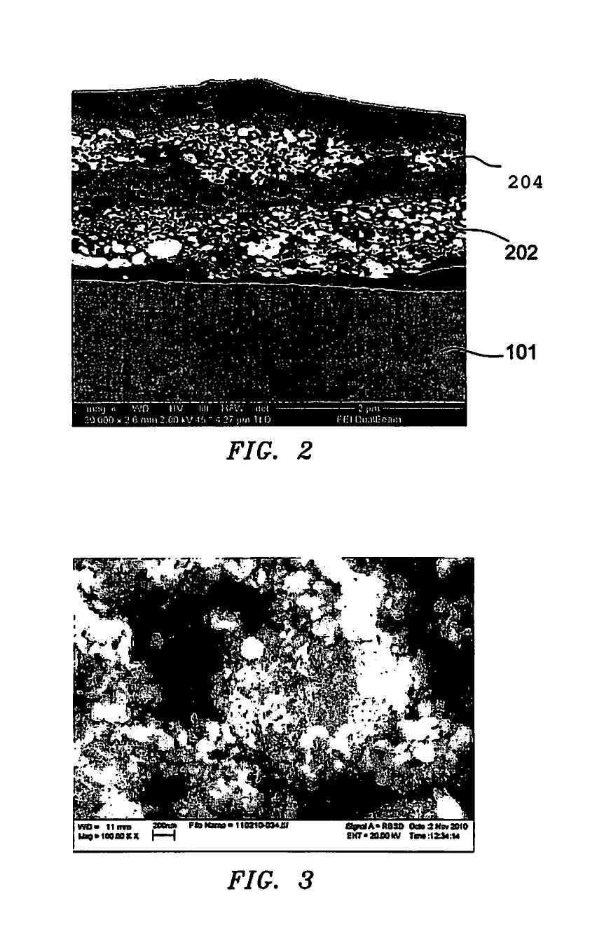

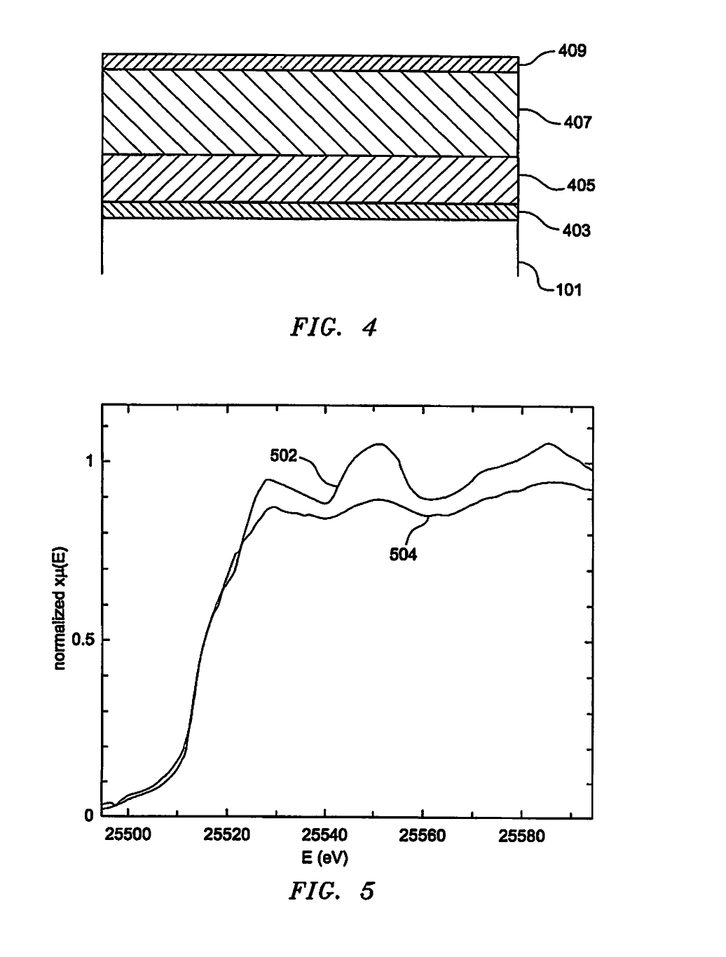

FIG. 3 is an SEM image showing Ag nanoparticles formed in the chitosan and noble metal nanoparticle coating deposited electrochemically on stainless steel, and FIG. 4 is a profile view illustrating a structure obtained at the cathode by simultaneous electrochemical deposition of an Ag/chitosan coating on surface 101. The electrode contains Cr, as in stainless steel type 304, or Cr and Molybdenum (Mo), as in stainless steel type 316.

As shown in FIG. 4, an Ag/chitosan coating is deposited on surface 101, which includes a Cr and Mo bearing stainless steel having an oxy-anion rich passive layer 403. The Ag/chitosan coating includes an Ag/nitro layer 405 deposited on the oxy-anion rich passive layer 403 of the surface 101 and a semi-crystalline Ag/chitosan layer 407 deposited on the Ag/nitro layer 405. The semi-crystalline Ag/chitosan layer 407 includes a functionalized surface 409. The Ag/nitro layer 405 includes a matrix of Ag ions and nitro functional groups, and the semi-crystalline Ag/chitosan layer 407 includes a matrix of Ag ions and chitosan.

By introducing an aqueous solution of AgNO₃ with concentrations ranging from between 0.001 and 1.0 M to an acetic acid/chitosan solution, high concentrations of Ag nanoparticles ranging in size from between 5 and 100 nm formed within three to ten seconds. As in the case of the electrophoretically deposited coating on stainless steel described above, UV radiation exposure may be used to expedite drying of the coating and enhance coating durability.

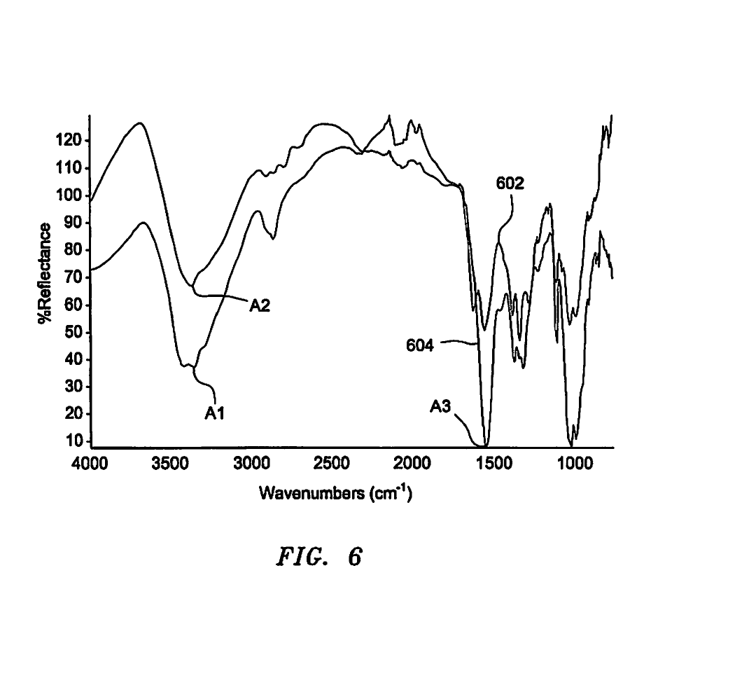

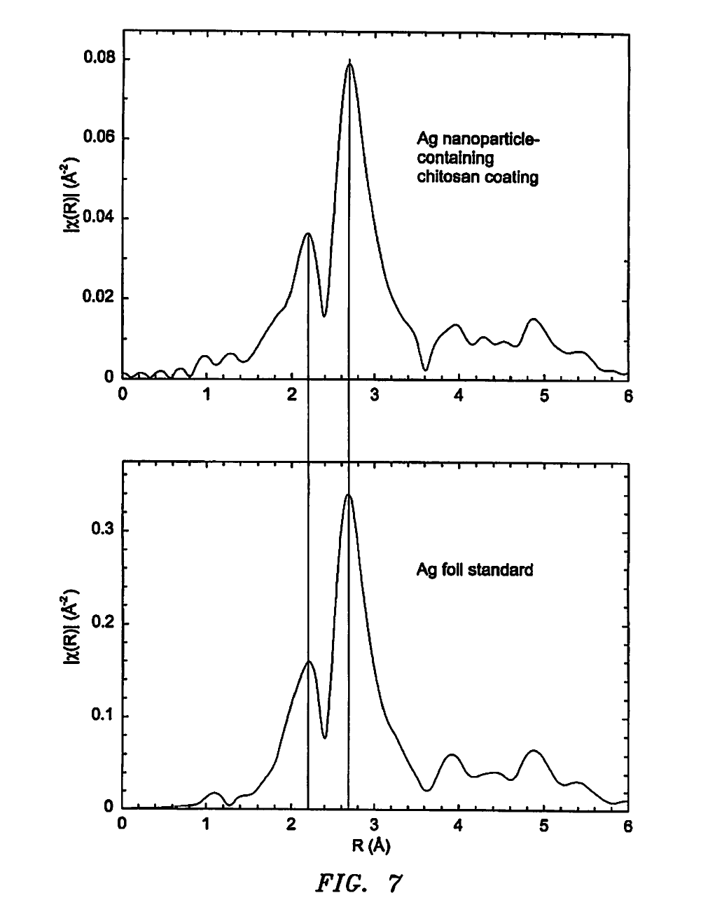

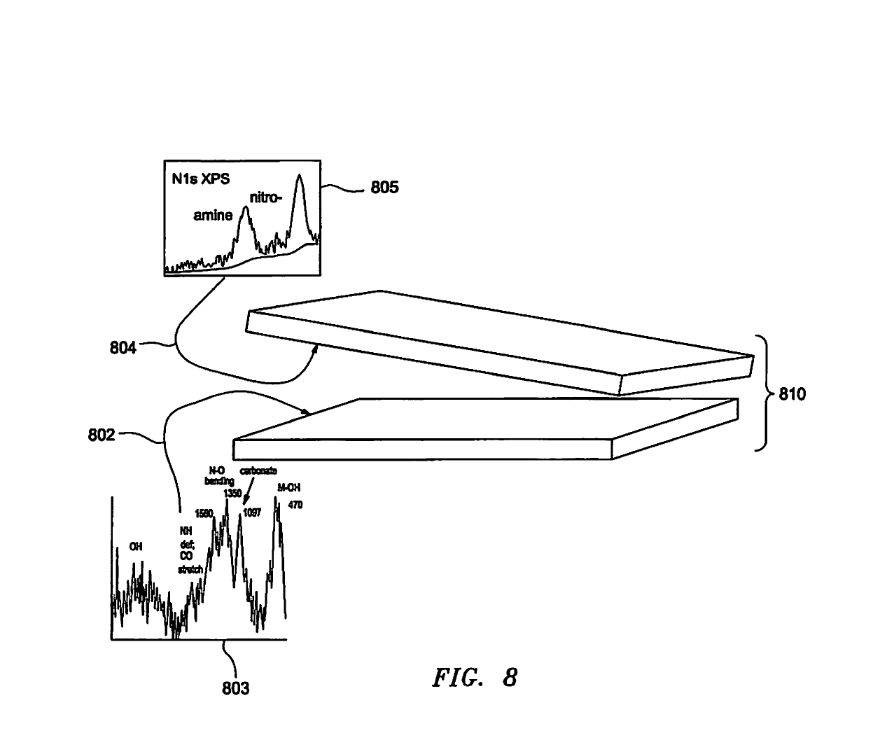

FIG. 5 is a graph of synchrotron X-ray absorption data comparing a silver foil standard 502 and silver nanoparticles 504 formed in chitosan on stainless steel, with the comparison indicating the metallic nature of the particles.

FIG. 6 provides results of Synchrotron FTIR spectroscopy performed on pure chitosan 602 and an electrochemically-formed layer with Ag nanoparticles 604, revealing several distinct differences, including the loss of a shoulder at wavenumbers 3440 (A1, A2) and replacement of the doublet at wavenumbers 1660/1590 by a single dominant peak at wavenumber 1600 (A3), both indicative of complexation at the amine group of chitosan. Additional changes occur in the peaks at wavenumbers 1300-1450 in the amide II region indicating additional complexation.

In accordance with another embodiment of the invention, a tailored anti-microbial coating is provided for cell scaffold applications. To test the electrochemically-formed chitosan and noble metal nanoparticle coating, a biological protocol was conducted by sterilizing Ag-chitosan coated substrates by immersing in 70% ethanol for two hours, after which the substrates were rinsed three times with sterile Phosphate Buffered Saline, and immediately transferred to a sterile tissue culture dish. The coatings were retained on the surface and remained stable following the treatment.

A cell suspension including murine pre-osteoblasts (MC3T3-E1) was seeded onto the Ag-chitosan substrates at a density of 5,000 cells per square centimeter. The cells were maintained in alpha Minimum Essential Medium supplemented with 10% fetal bovine serum and 1% penicillin-streptomycin. After five days of incubation at 37° C. (5% CO₂, humidified), the samples were fixed with 3.7% formaldehyde and stained with 4′,6-diamidino-2-phenylindole (DAPI) for nuclei visualization. Immunofluorescence micrographs were captured using a reflection microscope (Olympus IX71) with a DAPI filter cube.

Silver nanoparticles formed in the chitosan and noble metal nanoparticle coating retain metallic character and are stable for at least six months under general indoor atmospheric conditions of temperature and humidity, unlike Ag nanoparticles formed through simple wet chemical processes in chitosan, i.e., by use of chemical reductants, which reoxidize and agglomerate in less than twenty-four hours. The Ag and chitosan coating also remains stable on a type 304 stainless steel coupon following sterilization.

Microscopic analysis did not reveal cell growth on the coating. Furthermore, SEM Energy Dispersive Analysis by X-rays (EDAX) analysis showed only non-living organic residue from the solution and no cell growth, indicating that the coating is anti-microbial, which is particularly useful for coating biomedical equipment and implants. Testing of a second sample of chitosan coating without Ag nanoparticles revealed some osteoblast growth and attachment. Hence, by controlling Ag-nanoparticle incorporation and distribution, coatings are obtained that prohibit cell growth for scaffolds and act as anti-microbial surfaces, e.g., for biomedical instruments and devices.

FIG. 8 illustrates an assessment of bonding strength of chitosan electrochemically deposited on stainless steel according to the present invention. To determine the chemical nature of the bonding layer created by the deposited matrix, a stainless steel coupon 810 with deposited chitosan were immersed in liquid nitrogen for one minute. A portion of an Ag/chitosan coating 804 was separated from the steel surface 804, and chemical analysis by Raman and XPS was performed. FIG. 8 provides spectra of the surface layer 802 and an underside of surface 804, which were consistent with chitosan functional groups and bonding, and also consistent with formation of oxidized carbon and nitrogen species. A photoelectron spectra 805 obtained from the underside surface 804 indicates formation of nitro and carbonyl groups.

The observed formation of such nitro groups supports a mechanism of formation and remarkable mechanical properties generated by the deposited matrix. The oxidation of amino (N³⁻) to nitrate-like (N⁵⁺) groups is typically only possible under rather extreme conditions, and in the presence of a strongly oxidizing species, such as hydroxyl radicals. This formation of reactive hydroxyl radicals, which react between the initially bound layers of the coating and the subsequent, second gel-like layers of deposited chitosan, plays a significant role in development of the structure, chemistry and properties noted of the coating obtained by embodiments of the present invention. A Raman Spectra 803 obtained from the underside surface 802 of the stainless steel indicates residual amine and nitro-enriched chitosan. Further mechanical testing of electrochemically-deposited pure chitosan coatings indicated a coefficient of friction at least 0.16, preferably between 0.16 and 0.27, with elasticity of these coatings found to be at least 5 GigaPascals (GPa), preferably in a range of 5-7 GPa.

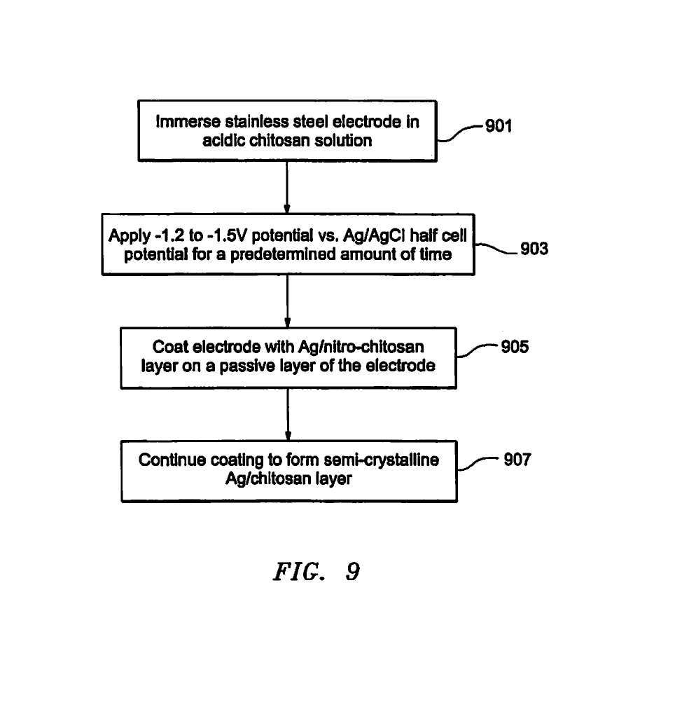

FIG. 9 is a flowchart summarizing a method for simultaneous electrochemical deposition of a noble metal/chitosan coating on a stainless steel surface. In step 901, the surface of the stainless steel electrode is immersed in an acidic chitosan solution including a predetermined concentration of a cationic noble metal. The predetermined concentration is between 0.001 and 1.0 M, e.g., 0.1 M. The cationic noble metal includes at least one of ruthenium, rhodium, palladium, silver, osmium, iridium, platinum, and gold.

According to an embodiment of the present invention, the cationic noble metal of Ag is added to the acidic chitosan solution as AgNO₃ in a predetermined concentration. The acidic chitosan solution includes 0.1-3.0 grams, e.g., 1 gram, of low molecular weight chitosan in 100 mL of deionized water with an additional 0.5 mL of a 50% by volume acetic acid solution, which provides a pH of between 4.0 and 5.0. Alternatively, the acidic chitosan is acidified with a hydrochloric acid solution, rather than acetic acid, added to provide the acidic chitosan solution at a pH of between 4.0 and 5.0.

In step 903, an electric potential of less than 1.0 V, e.g., −1.2 to −1.5 V, versus the Ag/AgCl half cell potential is applied between the submerged surface and the acidic chitosan solution for a predetermined time. The predetermined time is between three seconds and five minutes.

Application of the electric potential in step 903, results in the formation of a first layer including a matrix of the cationic noble metal and nitro-chitosan on the submerged surface in step 905. The first layer is coated on an oxy-anion rich passive layer of the stainless steel electrode. The nitro-chitosan is an interior portion of the first layer, providing improved adherence to the oxy-anion rich passive layer of the stainless steel surface.

In step 907, application of the electric potential continues to form a second layer including a semi-crystalline matrix of the cationic noble metal and chitosan over the first layer. The first layer of and the second layer are 2-10 microns thick and include 5-100 nm noble metal particles, e.g., Ag particles. In accordance with an embodiment of the invention, the surface is removed from the acidic chitosan solution and exposed to UV light for ten minutes at 365 nanometers wavelength, and 15,000 μW/cm² at a distance of 10 cm.

Using the methodology described above, samples are deposited on mechanically polished type 304 and 316 stainless steel coupons. The type 304 and 316 stainless steel substrates are used both to examine the role of substrate composition (Cr in 304 versus Cr and Mo in 316) on coating adhesion and interfacial chemistry. Both the 304 and 316 coupon types are commonly used in biomedical and other applications. Type 304 stainless steel is a widely used austenitic stainless steel. Type 316 steel is a common Mo-bearing austenitic stainless steel. Both 304 and 316 type steel are used extensively in medical devices, instruments and implants for energy applications, including transport lines, fuel cell components, and support surfaces for catalysts, as well as to provide structural support in electronics and for water treatment applications.

The polished coupons were approximately one square centimeter in size, and were mechanically polished rather than electropolished, a process shown to sometimes alter surface chemistry. All samples were ultrasonically cleaned in propanol and doubly distilled water. Acetic acid-based chitosan solution was used for deposition as acetic acid is environmentally benign, easy to dispose of, and produces excellent coating that resists deterioration over time, though the method may also be carried out using aqueous hydrochloric acid solution, as described above.

A PAR 600 potentiostat was used for electrochemical deposition, with voltage and time of deposition varied to optimize processing. Processing voltage was varied from −2.5 to −0.5 V for a saturated Ag/AgCl electrode in 0.1 V increments. Processing time was varied from five seconds to two minutes. Electrode/sample geometry during deposition was standardized through use of a custom test stand to hold the surface, i.e., the working electrode, at a set distance from the reference electrode, i.e., the Ag/AgCl half-cell and the Pt counter electrode.

Electrochemical solutions were varied in terms of concentration, with concentration of chitosan/acetic acid varying for pure chitosan coating deposition and concentration of chitosan/acetic acid and AgNO₃ varying for Ag-containing deposition. All deposition was conducted in open, i.e., aerated, aqueous solution.

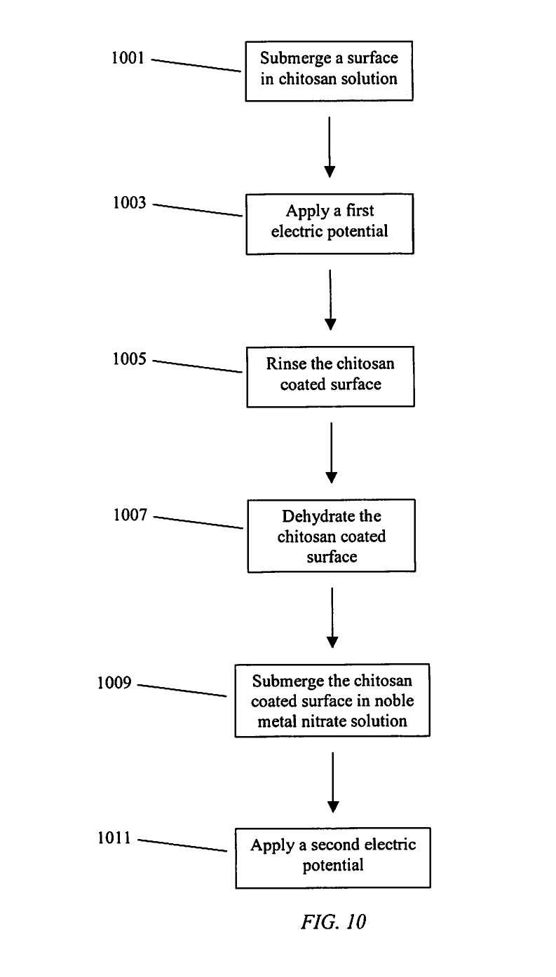

FIG. 10 is a flowchart summarizing a method for sequential electrochemically-induced deposition on an electrode according to the present invention. In step 1001, the method for sequential electrochemical deposition includes submerging a stainless steel surface of an object in a chitosan solution.

In step 1003, a first electric potential is applied between the submerged stainless steel surface of the object and the chitosan solution for a predetermined time to form a chitosan coating on the surface. An interior portion of the chitosan coating includes nitro-chitosan nanoparticles, which provide improved adherence of the chitosan coating to the oxy-anion rich passive layer of the stainless steel surface. The chitosan solution includes 0.1-−3.0 g, e.g., about 1.5 g, of low molecular weight chitosan in 120 ml deionized water. The chitosan coating is acidified to a pH of between 4.0 and 5.0 using acetic acid or hydrochloric acid. The first electric potential is applied at between −2.0 and −3.0 V vs. an Ag/AgCl electrode. The predetermined time is between 30 and 180 seconds, e.g., 120 seconds.

In step 1005, the object is removed from the chitosan solution and the chitosan coated surface is rinsed with deionized water to remove residual acid. In step 1007, the chitosan coated surface is dehydrated for about 24 hours in open air at ambient temperature, or at an elevated temperature of between 30-35° C. In step 1009, the chitosan coated surface is submerged in a solution having a predetermined concentration of a noble metal nitrate. The noble metal nitrate solution includes an AgNO₃ solution and the predetermined concentration is between 0.001 M and 1.0 M, e.g., 0.1 M.

In step 1011, a second electric potential is applied between the surface and the solution of the noble metal nitrate to deposit noble metal nanoparticles on the chitosan coated surface. The second potential is applied at between 0.5 and −3.0 V vs. an Ag/AgCl electrode, e.g., between −0.5 and −1.0 V, for a predetermined time. The predetermined time for application of the second potential is between 5 and 180 seconds, e.g. 60 seconds.

According to another embodiment of the present invention, an antimicrobial coating for a stainless steel surface is provided. The coating is formed by submerging a stainless steel surface of an object to be coated in a chitosan solution, applying a first electric potential between the submerged stainless steel surface and the chitosan solution for a predetermined time to form a chitosan coating on the stainless steel surface, rinsing the chitosan coated surface, dehydrating the chitosan coated surface, submerging the chitosan coated surface in a solution having a predetermined concentration of a noble metal nitrate, and applying a second electric potential between the chitosan coated surface and the solution of the noble metal nitrate to deposit noble metal particles on the chitosan coated surface.

A size and distribution of the noble metal nanoparticles deposited on the chitosan layer depends on an amount of the applied second potential and a length of the predetermined time the second potential is applied. The noble metal layer and chitosan layer can be removed from the stainless steel electrode by peeling the chitosan layer from the stainless steel electrode. The noble metal nanoparticles can be extracted from the chitosan layer by electrochemical methods, dissolution in acetic acid, or by filtration.

While this invention has been particularly shown and described with reference to certain embodiments thereof, it will be understood by those skilled in the art that various changes in form and details may be made therein without departing from the scope of the invention encompassed by the appended claims.

What is claimed is:

1. A method of electrochemical deposition comprising:
submerging a stainless steel surface of an object in a chitosan solution;
applying a first electric potential between the submerged stainless steel surface and the chitosan solution for a predetermined time to form a chitosan coating on the surface;
rinsing the chitosan coated surface;
dehydrating the chitosan coated surface;
submerging the chitosan coated surface in a solution having a predetermined concentration of a noble metal nitrate; and
applying a second electric potential between the chitosan coated surface and the solution of the noble metal nitrate to deposit noble metal particles on the chitosan coated surface.

2. The method of claim 1, wherein the chitosan solution is an aqueous solution comprising at least 0.1 grams of chitosan in 120 ml of deionized water.

3. The method of claim 2, wherein the first electric potential is applied at between −2.0 and −3.0 Volts.

4. The method of claim 3, wherein the predetermined time is between 60 and 180 seconds.

5. The method of claim 4, wherein the noble metal nitrate solution comprises a silver nitrate solution and the predetermined concentration is between 0.001 M and 1.0 M.

6. The method of claim 5, wherein the second electric potential is applied at between −0.5 and −1.0 Volts.

7. The method of claim 1, wherein the noble metal particles comprise at least one of ruthenium, rhodium, palladium, silver, osmium, iridium, platinum, and gold.

8. A method for aqueous electrochemical deposition to form a coating on a stainless steel surface, the method comprising:
submerging the stainless steel surface in an acidic chitosan solution with a predetermined concentration of a cationic noble metal; and
applying an electric potential between the submerged stainless steel surface and the acidic chitosan solution for a predetermined time to form a matrix of the cationic noble metal and nitro-chitosan on the submerged stainless steel surface,
wherein a functionally graded layer forms on the stainless steel surface that includes a semi-crystalline matrix of the cationic noble metal and chitosan.

9. The method of claim 8, wherein the acidic chitosan solution comprises at least 0.1 grams of chitosan in 100 ml deionized water with 0.5 ml of a 50% by volume acetic acid solution.

10. The method of claim 9, wherein the acidic chitosan solution has a pH between 4 and 5.

11. The method of claim 10, wherein the predetermined concentration of the cationic noble metal is between 0.001 and 1.0 M.

12. The method of claim 11, wherein the applied electric potential is less than 1.0 Volt.

13. The method of claim 12, wherein the predetermined time is between three seconds and five minutes.

14. The method of claim 8, wherein the cationic noble metal comprises at least one of ruthenium, rhodium, palladium, silver, osmium, iridium, platinum, and gold.

15. An antimicrobial coating for a stainless steel surface, wherein the coating is formed by submerging a stainless steel surface of an object in a chitosan solution, applying a first electric potential between the submerged stainless steel surface and the chitosan solution for a predetermined time to form a chitosan coating on the stainless steel surface, rinsing the chitosan coated surface, dehydrating the chitosan coated surface, submerging the chitosan coated surface in a solution having a predetermined concentration of a noble metal nitrate, and applying a second electric potential between the chitosan coated surface and the solution of the noble metal nitrate to deposit noble metal particles on the chitosan coated surface.

16. The antimicrobial coating of claim 15, wherein the chitosan solution is an aqueous solution comprising at least 0.1 grams of chitosan in 120 ml of deionized water.

17. The antimicrobial coating of claim 15, wherein the first electric potential is applied at between −2.0 and −3.0 Volts, and the predetermined time is between 60 and 180 seconds.

18. The antimicrobial coating of claim 15, wherein the noble metal nitrate solution comprises a silver nitrate solution and the predetermined concentration is between 0.001 M and 1.0 M.

19. The antimicrobial coating of claim 15, wherein the second electric potential is applied at between −0.5 and −1.0 Volts.

20. The antimicrobial coating of claim 15, wherein the noble metal particles comprise at least one of ruthenium, rhodium, palladium, silver, osmium, iridium, platinum, and gold.
